(19) United States
(12) Patent Application Publication
(10) Pub. No.: US 2016/0197580 A1
(43) Pub. Date: Jul. 7, 2016

(54) METHOD OF MODERATING AN OPERATING TEMPERATURE OF A PHOTOVOLTAIC PANEL

(71) Applicants: Boris Naneff, Sudbury (CA); Robert Mancini, Bolton (CA); Les Lisk, Coniston (CA); John Hood, Sudbury (CA)

(72) Inventors: Boris Naneff, Sudbury (CA); Robert Mancini, Bolton (CA); Les Lisk, Coniston (CA); John Hood, Sudbury (CA)

(21) Appl. No.: 15/067,285

(22) Filed: Mar. 11, 2016

Related U.S. Application Data
(62) Division of application No. 13/452,282, filed on Apr. 20, 2012.
Application No. 13/452,282 is a continuation of application No. PCT/CA2010/001682, filed on Oct. 22, 2010.
(60) Provisional application No. 61/253,942, filed on Oct. 22, 2009.

(51) Int. Cl. H02S 40/42; H02S 30/10; H02S 40/44

(52) U.S. Cl. CPC H02S 40/425; H02S 40/44; H02S 30/10

(57) ABSTRACT

A method of moderating an operating temperature of a photovoltaic panel. The method includes forming a power generation subassembly that has a body element including concrete and a photovoltaic power generating module with the photovoltaic panel operable at the operating temperature within a predetermined range of operating temperatures and means for attaching the photovoltaic panel to the body element. A circuit is provided with a heat transfer medium circulating therethrough, the circuit including a loop circuit and an end portion. The body element includes an engagement portion that is positioned between and engaged with the photovoltaic panel and the loop circuit. The power generating subassembly is incorporated into a structure. Heat energy is permitted to be transferred between the photovoltaic panel and the heat transfer medium via the engagement portion to maintain the operating temperature of the photovoltaic panel within the predetermined range of operating temperatures.

This application is a divisional of co-pending application Ser. No. 13/452,282, filed on Apr. 20, 2012, which is a continuation of International patent application no. PCT/CA2010/001682, filed on Oct. 22, 2010, which claims the benefit of U.S. Provisional Application No. 61/253,942, filed on Oct. 22, 2009, each of which is hereby incorporated by reference herein in its entirety.

### FIELD OF THE INVENTION

The present invention is a method of moderating an operating temperature of a photovoltaic panel.

### BACKGROUND OF THE INVENTION

In conventional photovoltaic power generation systems, the temperature of the photovoltaic cells has a significant impact on the efficiency at which the cells operate. In particular, where photovoltaic cells operate at an elevated temperature (i.e., a temperature above a range of operating temperatures in which the cell operates at peak efficiency), the efficiency of the photovoltaic cells is reduced. This problem is exacerbated by the heat energy released upon exposure of the photovoltaic cells to light, which tends to increase the operating temperature of the photovoltaic cell. However, cooling the photovoltaic cells (i.e., in order to improve the efficiency thereof) typically requires energy inputs, which adversely affects the overall energy efficiency of the system.

For instance, most photovoltaic cells on the market now have a solar conversion efficiency between about 15% and about 27%. The balance of the energy (i.e., between about 85% and about 73%) generally is converted to heat, which is usually wasted. Accordingly, in the prior art, photovoltaic cells are often mounted to allow for transfer of heat energy from the photovoltaic cells to ambient air, to permit some cooling of the cells by the ambient air, due to convection (i.e., without energy inputs).

Furthermore, in most photovoltaic power generation systems, the waste heat adversely affects the efficiency of the photovoltaic cells by about 10% to about 20%. Photovoltaic cells can generate much more heat than electricity. Such heat is, in conventional systems, transferred to ambient air and, to a limited extent, to structural elements (e.g., walls or roofs), where the heat is dissipated. Such heat is either not used, or is inefficiently used.

Another problem is that of “shading”, which also adversely affects the efficiency of the photovoltaic cell. For example, in a 50 W output system, the power generated drops to 38 W if the photovoltaic cells are about 50% shaded. Accordingly, a relatively small shaded area of the photovoltaic cell can have a relatively large impact on the efficiency thereof.

### SUMMARY OF THE INVENTION

For the foregoing reasons, there is a need for a method of moderating an operating temperature of a photovoltaic panel which overcomes or mitigates one or more of the disadvantages of the prior art.

In its broad aspect, the invention provides a method of moderating an operating temperature of at least one photovoltaic panel. The method includes forming one or more power generation subassemblies, each power generating subassembly having one or more body elements including concrete, and one or more photovoltaic power generation modules. Each photovoltaic power generation module includes the photovoltaic panel operable at the operating temperature within a predetermined range of operating temperatures, and means for attaching the photovoltaic panel to the body element. One or more circuits are provided, each circuit having a heat transfer medium therein in fluid communication with a pump, for circulating the heat transfer medium through the circuit. Each circuit includes one or more loop circuits and an end portion. One or more engagement portions are provided in the body element. The engagement portion is positioned between and engaged with the photovoltaic panel and the loop circuit. The power generation subassembly is incorporated into a structure. Heat energy is permitted to be transferred between the photovoltaic panel and the heat transfer medium via the engagement portion to maintain the operating temperature of the photovoltaic panel within the predetermined range of operating temperatures.

In another aspect, the invention provides a method of moderating an operating temperature of one or more photovoltaic panels. The method includes forming one or more power generation subassemblies, each power generation subassembly having one or more body elements including concrete and one or more photovoltaic power generation modules. The power generation module includes the photovoltaic panel operable at the operating temperature within a predetermined range of operating temperatures and means for attaching the photovoltaic panel to the body element. One or more circuits are provided, each circuit having a heat transfer medium therein in fluid communication with a pump, for circulating the heat transfer medium through the circuit. The circuit includes one or more loop circuits and an end portion. The power generation subassembly is incorporated into a structure. Heat energy is permitted to be transferred between the photovoltaic panel and the heat transfer medium to maintain the operating temperature of the photovoltaic panel within the predetermined range of operating temperatures.

### BRIEF DESCRIPTION OF THE DRAWINGS

The invention will be better understood with reference to the attached drawings, in which:

FIG. 1 is an isometric view of an embodiment of a wall assembly of the invention;

FIG. 2 is an isometric view of a formwork assembly for forming a body element of the wall assembly of FIG. 1;

FIG. 3 is an isometric view of the formwork assembly of FIG. 2 showing poured concrete therein;

FIG. 4A is a cross-section of an embodiment of a wall assembly of the invention, drawn at a smaller scale;

FIG. 4B is a cross-section of an alternative embodiment of the wall assembly of the invention;

FIG. 4C is a cross-section of another alternative embodiment of the wall assembly of the invention;

FIG. 4D is a cross-section of another embodiment of the wall assembly of the invention;

FIG. 5A is a cross-section of a prior art wall in a structure, with a schematic temperature profile, drawn at a smaller scale;

FIG. 5B is a cross-section of an embodiment of a wall in a structure including the wall assembly of the invention with a schematic temperature profile therefor;

FIG. 6 is a schematic diagram of an embodiment of a power generation module of the invention;

FIG. 7 is an isometric view of an embodiment of a wall system of the invention, drawn at a larger scale;

FIG. 8 is a plan view of another embodiment of a loop circuit of the invention;

FIG. 9 is a plan view of an alternative embodiment of the loop circuit of the invention;

FIG. 10 is a schematic diagram of an embodiment of a heat exchange subassembly of the invention;

FIG. 11 is a schematic diagram of another embodiment of the heat exchange subassembly of the invention;

FIG. 12 is schematic diagram of an alternative embodiment of the heat exchange subassembly of the invention;

FIG. 13 is a schematic diagram of an embodiment of a method of the invention;

FIG. 14 is an isometric view of an embodiment of a heat exchange subassembly of the invention, drawn at a smaller scale;

FIG. 15 is a schematic illustration of an embodiment of a wall system of the invention; and

FIG. 16 is a schematic illustration of another embodiment of the wall system of the invention.

### DETAILED DESCRIPTION

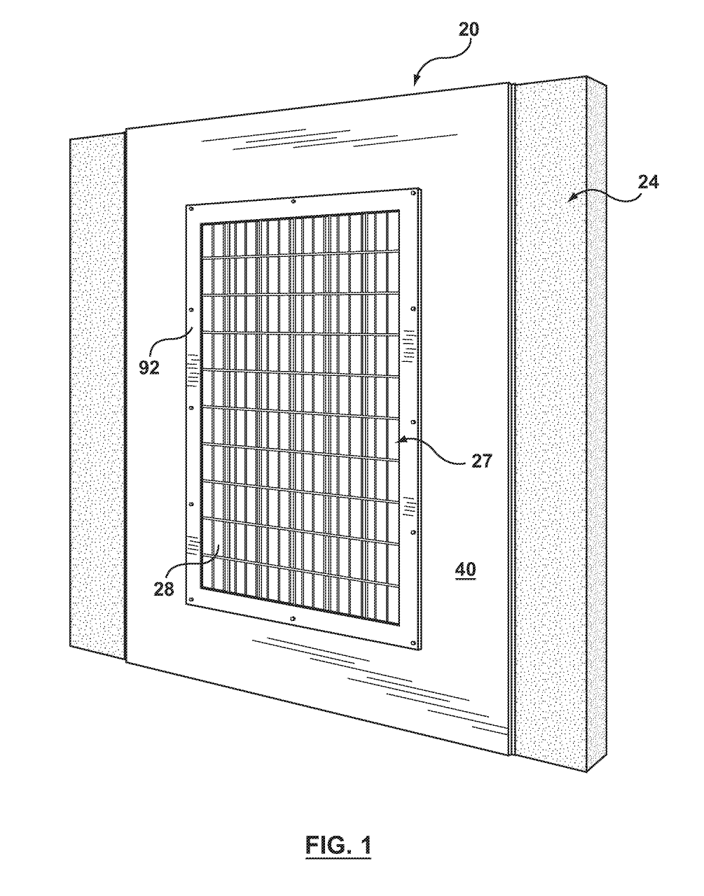

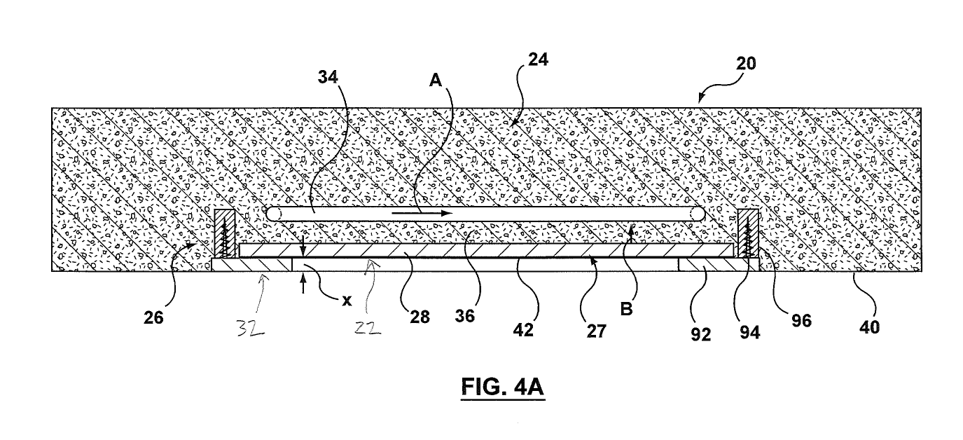

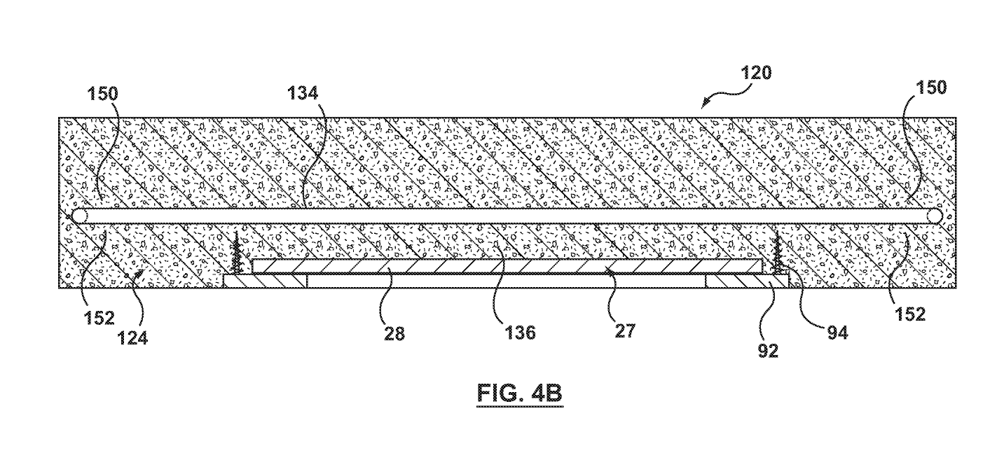

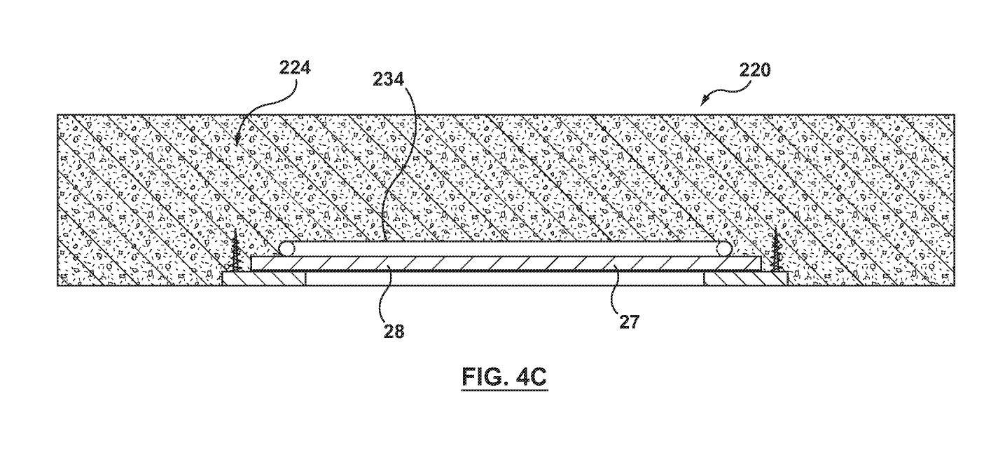

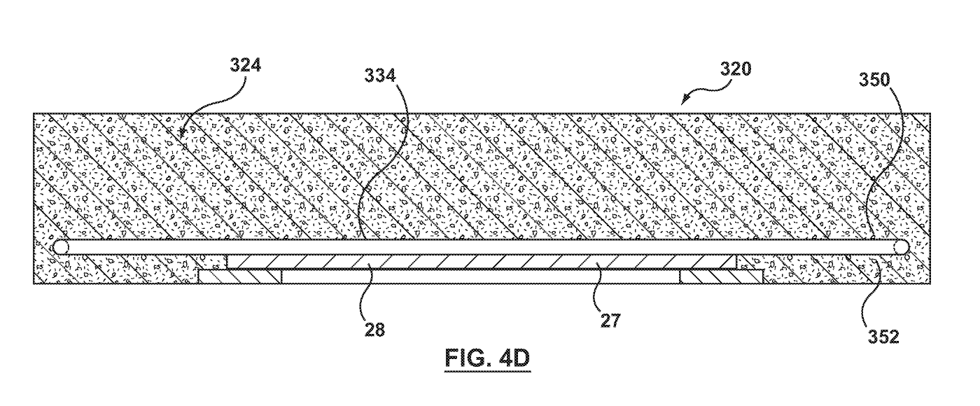

In the attached drawings, like reference numerals designate corresponding elements throughout. Reference is first made to FIGS. 1-4A to describe an embodiment of a wall assembly of the invention indicated generally by the numeral 20. In one embodiment, the wall assembly 20 preferably includes a power generation subassembly 22 (FIG. 4A) having one or more body elements 24 and one or more photovoltaic power generation modules 26. Preferably, each photovoltaic power generation module 26 includes one or more photovoltaic panels 27 with one or more photovoltaic cells 28 for converting light energy into electricity, and means 32 for attaching the photovoltaic panel 27 to the body element 24. As is known, the photovoltaic cells 28 are adapted to operate at an operating temperature, within a range of operating temperatures. It is preferred that the wall assembly 20 also includes one or more loop circuits 34 (FIG. 4A) adapted to permit flow of a heat transfer medium therethrough, as will be described. As will also be described, the loop circuit 34 is at least partially engaged with the power generation subassembly 22 for transfer of heat energy therebetween via conduction for moderating the operating temperature of the photovoltaic cells 28.

In one embodiment, and as can be seen in FIG. 4A, the loop circuit 34 preferably is at least partially engaged with the body element 24 for transfer of heat energy therebetween via conduction. The wall assembly 20 preferably includes a number of photovoltaic cells 28 in the photovoltaic panel 27, and may include more than one photovoltaic panel 27. Preferably, the photovoltaic panel 27 is at least partially engaged with one or more engagement portions 36 of the body element 24 (FIG. 4A). Also, the loop circuit 34 preferably is at least partially engaged with the body element 24 at the engagement portion 36.

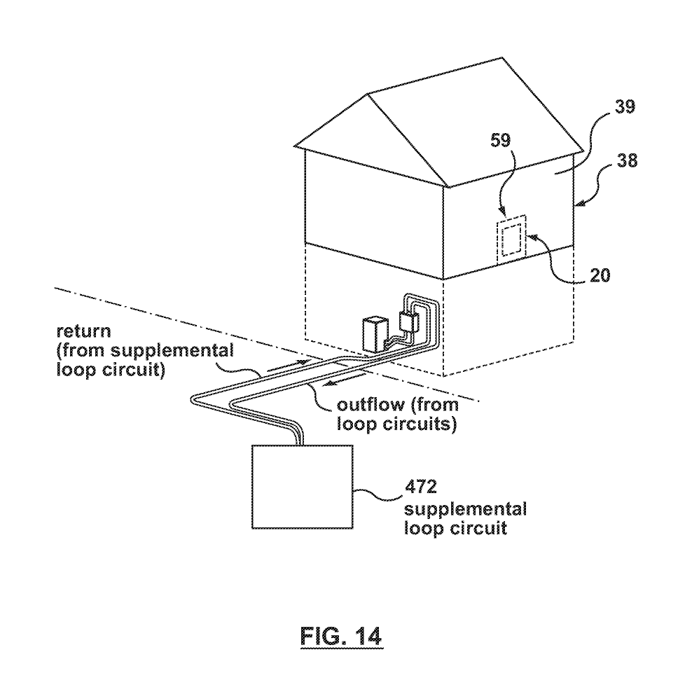

As can be seen in FIG. 1, the body element 24 of the wall assembly 20 preferably is a relatively thick piece of concrete in which the photovoltaic panel 27 is mounted, so that a number of the wall assemblies 20 may be included in a structure 38 (e.g. a building, as shown in FIG. 14) as a structural (i.e., load-bearing) element thereof, to at least partially form an exterior surface of the structure. Alternatively, the wall assembly 20 may be cladding (i.e., non-load-bearing elements) positioned on a structure to at least partially form an exterior surface thereof. Those skilled in the art will appreciate that the wall assembly 20 (or a number thereof, as the case may be) may be retrofitted onto a structure, particularly as non-load-bearing elements.

It will be understood that the wall assembly 20 may be used to form any part or parts of a structure, whether as load-bearing elements or otherwise. For example, the wall assembly 20 may be included in a roof of the structure, in addition to, or instead of, being included in substantially vertical walls of the structure. Preferably, several wall assemblies may be used to cover a particular portion of a structure, to form an exterior surface of the structure. Where the structure 38 is a building, the wall assembly 20 may be used to moderate the temperature of an indoor fluid 39 in the building, as will be described. In addition, or alternatively, the wall assembly 20 may be used to moderate heat transfer out of the building, as will also be described.

It will be understood that the structure need not necessarily be a building. The structure may be, for example, a fence. Also, it will be understood that the body element may have any suitable size or shape. Preferably, the body element is sufficiently strong that the wall assembly may be precast and transported to the job site for installation without adversely affecting its structural integrity. For the purposes hereof, it will be understood that one or more wall assemblies may be included in a wall unit 59, the wall unit 59 being included in the structure 38, whether as a load-bearing element or otherwise.

As shown in FIG. 4A, the body element 24 of the wall assembly 20 preferably is at least partially defined by an exterior surface 40 thereof. When the wall assembly 20 is installed or mounted in the structure 38 (i.e., regardless of whether the wall assembly 20 is used as a load- bearing element, or as a non-load-bearing element), the exterior surface 40 of the body element 24 at least partially defines an external surface 41 of the structure 38 (FIG. 14). As can be seen in FIGS. 1 and 4A, the photovoltaic panel 27 preferably is mounted in the body element 24 so that a front surface 42 of the photovoltaic panel 27 is exposed to sunlight, when the wall assembly 20 is installed or mounted in the structure 38.

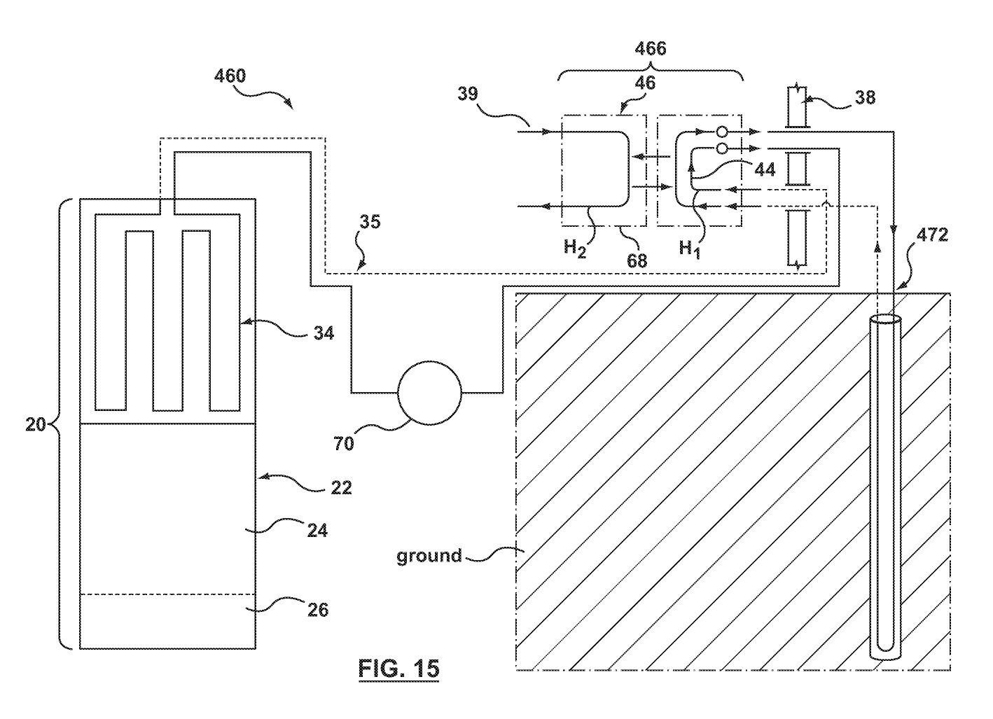

As will be described, it is understood that the loop circuit 34 is in fluid communication with an end portion 44 (FIG. 15) located proximal to a heat pump subassembly 46, for heat exchange between the heat transfer medium in the end portion and a heat exchange medium in the heat pump (FIG. 15). Those skilled in the art will appreciate that, in order for heat transfer to the heat transfer medium in the loop circuit 34 to take place, the heat transfer medium in the loop circuit 34 is at a lower temperature than the photovoltaic panel and/or the part of the body element 24 in contact with the loop circuit 34. Preferably, this is achieved by including the loop circuit 34 in a heat exchange subassembly (FIG. 14), which is discussed further below.

As will be appreciated by those skilled in the art, the location of the loop circuit 34 in the wall assembly 20 relative to the photovoltaic panel 27 affects the efficiency of the transfer of heat energy to the heat transfer medium in the loop circuit 34. In the embodiment illustrated in FIGS. 1-4A, the body element 24 includes the engagement portion 36, which is positioned between the loop circuit 34 and the photovoltaic panel 27 and engaged therewith, for heat transfer between the heat transfer medium in the loop circuit 34 and the photovoltaic cells 28, as well as heat transfer between the heat transfer medium in the loop circuit 34 and the body element 24. The heat transfer medium is pumped through the loop circuit 34 in a predetermined direction. As illustrated in FIG. 4A, the direction in which the heat transfer medium is pumped is as indicated by arrow “A”. However, it will be appreciated by those skilled in the art that the heat transfer medium may, alternatively, flow in the opposite direction, depending on how the loop circuit 34 is arranged.

For instance, when the ambient temperature outside the building is relatively high (e.g., when the ambient temperature is higher than the desired temperature of the indoor fluid) and light energy is processed at the photovoltaic cells 28, heat energy is transferred from the photovoltaic panel 27 to the heat transfer medium in the loop circuit 34, as indicated by arrow “B” in FIG. 4A. Similarly, heat energy in the body element 24 resulting from light directed upon the exterior surface 40 of the body element 24 is, to an extent, transferred to the heat transfer medium by conduction. Those skilled in the art will appreciate that a certain amount of heat energy is also radiated into the ambient air from the photovoltaic panel 27 and the exterior surface 40 of the body element 24.

It will be understood that the range of operating temperatures in which the photovoltaic cells 28 are adapted to operate (referred to above) are the optimum operating temperatures therefor. The loop circuit 34 preferably is positioned so that sufficient heat energy is transferred to the heat transfer medium in the loop circuit 34 to maintain the photovoltaic cells 28 at one or more operating temperatures within the range of optimum operating temperatures, thereby enabling the photovoltaic cells 28 to operate at relatively high efficiency.

In addition, the invention herein provides for relatively efficient utilization of the heat energy removed from the photovoltaic cells 28 and from the body element 24.

The heat transfer medium may be any suitable fluid. The warmed heat transfer medium is pumped to the end portion 44 and through the heat pump 46, where heat is transferred from the heat transfer medium (indicated at “H₁” in FIG. 15 for clarity) in the end portion 44 to the heat exchange medium (indicated at “H₂” in FIG. 15 for clarity of illustration). The heat thereby transferred may then be used to cool the indoor fluid 39 (FIG. 15) (e.g., air in the structure 38), using methods which are known in the art.

Similarly, when the ambient temperature outside the building is relatively low and light energy is processed by the photovoltaic cells 28, heat energy (i.e., heat energy generated by the operation of the photovoltaic cells) is transferred from the photovoltaic panel 27 to the heat transfer medium in the loop circuit 34, as indicated by an arrow “B” in FIG. 4A. In this situation, because the body element 24 is relatively cool, the warmed heat transfer medium in the loop circuit 34 has the effect of warming the body element 24, to a limited extent. Heat is transferred from the warmed heat transfer medium in the end portion 44 to the heat exchange medium. The transferred heat preferably is then used to heat the indoor fluid 39. (Those skilled in the art will appreciate that heat energy is lost with each transfer.)

From the foregoing, it can be seen that the wall assembly 20 of the invention has the following advantages. First, due to heat transfer to the heat transfer medium in the loop circuit 34, an amount of the heat energy generated by the operating photovoltaic cells 28 is removed from the photovoltaic panel 27, resulting in more efficient operation of the photovoltaic cells 28.

Second, the body element 24 functions as a solar collector. For instance, in circumstances where the heat energy otherwise would build up in the body element 24, the heat energy is also removed due to transfer of heat energy to the heat transfer medium in the loop circuit. The heat energy may be, for example, generated by the operation of the photovoltaic cells 28, and/or resulting from sunshine directed onto the exterior surface 40 of the body element 24 and onto the photovoltaic panel 27. Once transferred (i.e., in part) to the heat transfer medium, such heat energy can be used, e.g., in connection with a heat pump, to heat or cool the indoor fluid in the building. The heat transfer medium circulating in the loop circuit 34 captures solar thermal energy that would normally pass through a wall (i.e., the body element 24) to become a thermal solar load to the building air conditioning system.

Third, the photovoltaic panel 27 uses solar power to generate electricity, which can, e.g., be utilized in the building's distribution network, as will be described.

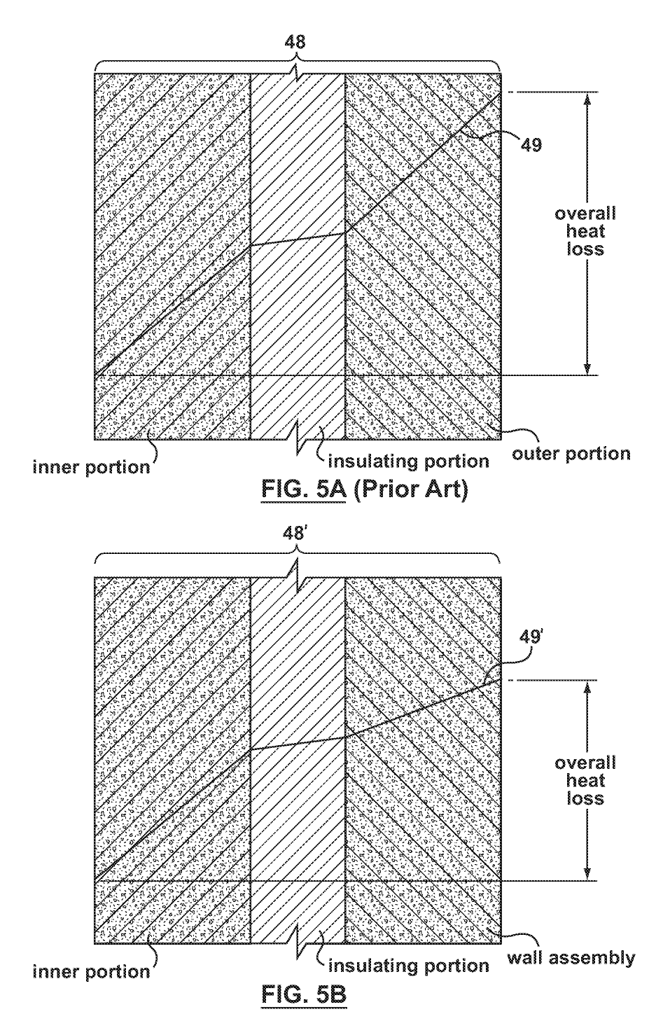

Fourth, as illustrated in FIGS. 5A and 5B, because it is heated, the body element 24 moderates heat transfer (i.e., heat loss) through the wall. In FIG. 5A, a typical wall 48 of the prior art is shown, with a typical temperature profile 49. As illustrated in FIG. 5A, the typical wall 48 includes inner and outer portions, and an insulating portion therebetween. The typical temperature profile in the prior art outer portion is relatively steep, indicating that there is substantial heat loss. In contrast, FIG. 5B illustrates the temperature profile that is anticipated to result from replacement of the conventional outer portion by the wall assembly of the invention. In FIG. 5B, a wall 48′ of the structure includes the wall assembly of the invention as the outer portion, but the inner portion and the insulating portion are conventional. (The loop circuit 34 is omitted from FIG. 5B for clarity of illustration.) As indicated in FIG. 5B, it is anticipated that, because the wall assembly is generally at a higher temperature than the conventional outer portion of a wall, the heat loss through the wall is much less than the heat loss which occurs through the conventional wall, i.e., as illustrated in FIG. 5A. It is anticipated that the wall 48′ has a temperature profile 49′. It is believed that the heat loss through the inner portion and the insulating portion in the wall of FIG. 5B is substantially similar to the heat loss through the corresponding portions in the wall of FIG. 5A. However, it is also believed that there would be much less heat loss through the wall assembly portion of the wall of FIG. 5B, resulting in much lower overall heat loss.

The loop circuit may have different forms, and may be positioned relative to the photovoltaic panel 27 in different ways. In another embodiment of the wall assembly 120, illustrated in FIG. 4B, the photovoltaic panel 27 preferably is at least partially engaged with the engagement portion 136 of the body element 124, which additionally includes one or more support portions 150 thereof adjacent to the engagement portion 136 thereof (FIG. 4B). The loop circuit 134 is at least partially engaged with the engagement portion 136 and with at least a preselected part 152 of the support portion 150, for moderating heat energy transfer through the body element 124.

In the wall assembly 120, because the loop circuit 134 extends into the support portion 150, relatively more heat is transferred between the loop circuit 134 and the body element 124 than in the embodiment illustrated in FIG. 4A. Also, in this embodiment, heat tends to be spread more evenly throughout the body element 124 than in the embodiment illustrated in FIG. 4A.

Another alternative embodiment of the wall assembly 220 is illustrated in FIG. 4C. In this embodiment, it is preferred that, the loop circuit 234 is at least partially engaged with the photovoltaic panel 27. In this embodiment, the direct engagement of the loop circuit 234 and at least part of the photovoltaic panel 27 is thought to result in a more efficient transfer of heat energy to the loop circuit 234 (i.e., to the heat transfer medium therein) from the photovoltaic panel 27, i.e., as compared to the wall assemblies 20, 120 illustrated in FIGS. 4A and 4B respectively.

The benefits of having the engagement portion of the body element positioned between the photovoltaic cell and the loop circuit 34 are believed to be as follows. First, the engagement portion tends to have a beneficial diffusing effect, i.e., tending to spread heat energy generated at the photovoltaic cells throughout the engagement portion, and also into parts of the body element adjacent to the engagement portion. Because cured concrete is relatively thermally conductive, the transfer of heat energy through the engagement portion takes place at an efficiency comparable to that of heat transfer directly from the photovoltaic panel to the loop circuit 34. Second, the rear wall of the conventional photovoltaic panel tends to become scratched or otherwise damaged relatively easily. Therefore, if the loop circuit 34 is to be mounted so that it engages the photovoltaic panel 27, the photovoltaic panel should include an appropriately strong rear wall, which would add cost and complication, and may adversely affect the efficiency of heat transfer from the photovoltaic cells.

Yet another embodiment of the wall assembly 320 is illustrated in FIG. 4D. Preferably, the body element 324 additionally includes a support portion 350 adjacent to the engagement portion 336, and the loop circuit 334 is at least partially engaged with the body element 324 in at least a predetermined part 352 of the support portion 350, for moderating heat energy transfer through the body element 324. Part of the loop circuit 334 is engaged with the photovoltaic panel 27, for a more efficient transfer of heat energy to the loop circuit 334 (i.e., to the heat transfer medium therein) from the photovoltaic panel 27. In this embodiment, as in the embodiment illustrated in FIG. 4B, the larger loop circuit 334 is thought to result in more efficient heat transfer to the heat transfer medium in the loop circuit 334, as well as more even distribution of heat energy throughout the body element 324, i.e., as compared to the wall assembly illustrated in FIG. 4C.

As illustrated in FIGS. 14 and 15, an embodiment of a wall system 460 of the invention preferably includes the conventional heat pump subassembly 46, adapted for controlling the temperature of the indoor fluid 39. For instance, the indoor fluid 39 may be air inside the building 38 (e.g., a residence, or a commercial building). As is well known in the art, in this situation, the heat exchange medium is used (generally, with heating or cooling elements (not shown)) to heat or cool the air (and/or another indoor fluid, as required) inside the building. As is known, a heat pump may distribute the heat by means of a hydronic (hot water) system, e.g., through baseboard radiators or an in-floor hydronic heating system. Alternatively, the system may be used to cool the indoor fluid. The system may also be used, for example, to heat domestic hot water using a desuperheater installed in the heat pump (i.e., the desuperheater takes the hot water after it leaves the compressor in the heat pump). Excess hot water is available in the heat pump cooling mode and is also available in the heating mode during mild weather when the heat pump is above the balance point and is not working to full capacity. Because the operation of the heat pump assembly 46 in connection with heating and/or cooling the indoor fluid is generally conventional in regard to its heating or cooling of the indoor fluid, it is not necessary to describe such operation in detail. It will be understood that although reference is made to only one heat pump assembly, the invention herein may be used with a number of heat pump assemblies, e.g., such as multiple heat pumps used in a large building.

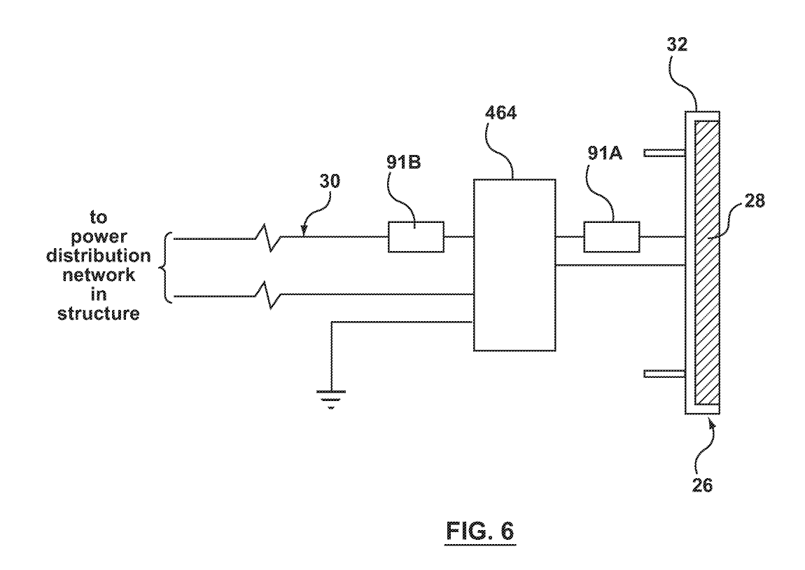

In another embodiment, the invention provides the wall system 460 (FIG. 15), which includes a power generation subassembly 22, with the body element 24, and the photovoltaic power generation module 26 (schematically illustrated in FIG. 15). The photovoltaic power generation module 26 preferably includes one or more photovoltaic panels 27 with one or more photovoltaic cells 28 (not shown in FIG. 15) for converting light energy into electricity, as described above. Also, the wall system 460 includes one or more regulators 464 (FIG. 6), for regulating the electricity generated by the photovoltaic cells 28, and other elements described above, e.g., means 32 for attaching the photovoltaic cells 28 to the body element 24 (as illustrated, e.g., in FIG. 4A). Preferably, the system also includes a heat exchange subassembly 466 with the heat pump subassembly 46 for moderating the indoor fluid's temperature, with a heat exchanger 68 having the heat exchange fluid circulatable therein. The wall system 460 includes a circuit 35 in fluid communication with a pump 70, for circulating the heat transfer medium through the circuit 35 (FIG. 15). Preferably, the circuit 35 includes the end portion 44 positioned proximal to the heat pump subassembly for heat exchange between the heat transfer medium in the end portion and the heat exchange fluid in the heat exchanger, and at least one loop circuit 34 in fluid communication with the end portion. As described above, it is also preferred that the loop circuit 34 is at least partially engaged with the power generation subassembly 22 for transfer of heat energy therebetween via conduction, for moderating the operating temperature of the photovoltaic cells.

In one embodiment, the heat exchange subassembly 466 preferably also includes one or more supplemental loop circuits 472 in which a supplemental heat exchange medium is circulatable, for heat exchange between the supplemental heat exchange medium and the heat exchange fluid in the heat exchanger (FIGS. 14, 15). Those skilled in the art will appreciate that the supplemental loop circuit 472 may be any suitable circuit in which the heat transfer medium is circulatable. Preferably, the supplemental loop circuit 472 is any suitable ground energy storage device, e.g., a thermal well, a ground loop, or the ground energy storage device disclosed in U.S. patent application no. 12/728,366, published as US 2010/00236750. However, excess heat energy may be stored in any suitable element, e.g., water in a swimming pool, or domestic hot water. In one embodiment, the supplemental loop circuit 472 is a closed loop ground exchanger (FIG. 15).

In the winter heating cycle, the heat transfer medium circulates through the loop circuit(s) 34 and the supplemental loop circuit 472. In this situation, the heat transfer medium is warmer than the body element(s) 24 due to the heat stored in the ground in the summer, so that the body element(s) 24 is (are) warmed by the heat transfer medium Because the wall assembly 20 is warmer than the ambient (outdoor) temperature, the heat transfer medium reduces heat loss through the wall assembly 20. As the stored energy in the ground is used to warm the wall assembly 20, the ground gradually cools down.

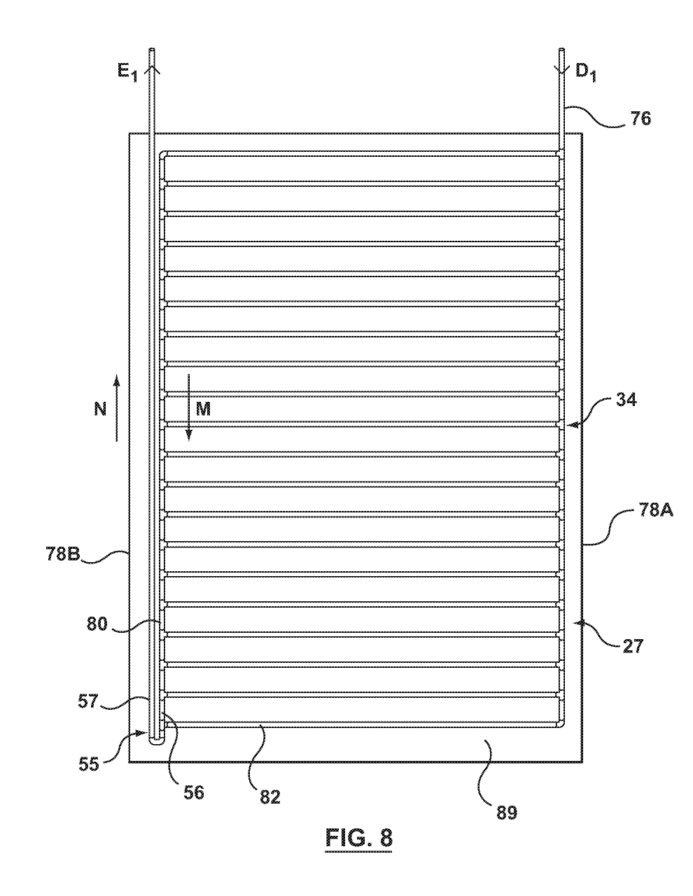

One layout arrangement for the loop circuit 34 is illustrated in FIG. 8. In FIG. 8, the position of the loop circuit 34 is shown relative to a rear side 89 of the photovoltaic panel 27. It will be understood that the body element 24 is omitted from FIG. 8 for clarity of illustration. As can be seen in FIG. 8, an inlet tube 76 (through which the heat transfer medium is introduced to the loop circuit, in the direction indicated by arrow “D₁”) is positioned to be substantially aligned with an edge 78A of the photovoltaic panel 27, and inside the edge 78A. An outlet tube 80 is positioned substantially aligned with an opposite edge 78B of the photovoltaic panel 27, and inside the edge 78B. Preferably, a number of transverse tubes 82 join the inlet and outlet tubes 76, 80. Heated heat transfer medium exits the loop circuit via the outlet tube 80, as indicated by arrow “E₁” in FIG. 8. In the arrangement illustrated in FIG. 8, the transverse tubes 82 are positioned spaced apart at substantially equal distances.

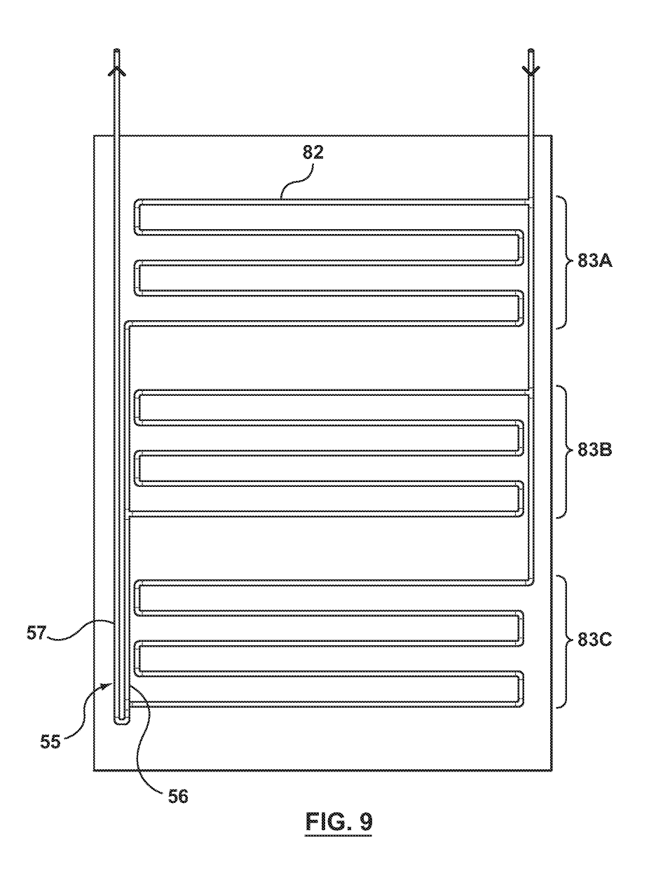

An alternative arrangement of the loop circuit 34 is shown in FIG. 9. In this arrangement, the transverse tubes 82 are positioned in groups 83A, 83B, 83C which are spaced apart from each other by predetermined distances. The arrangement illustrated in FIG. 9 may be used, for example, where the wall assembly is relatively large.

The optimum arrangement for the loop circuit 34 in any wall assembly 20 is primarily dependent on the extent to which the temperature of the heat transfer medium in the loop circuit 34 increases. As the heat transfer medium moves through the loop circuit (i.e., from the inlet to the outlet thereof), heat energy is transferred to the heat transfer medium, and the temperature of the heat transfer medium increases accordingly. However, once the temperature of the heat transfer medium is substantially equal to the temperature of the body element 34 (i.e., at the part(s) of the body element which are engaged with the loop circuit 34), no further heat transfer will occur. Accordingly, the loop circuit may be arranged so that parts thereof are positioned in or on the body element 24 so as to optimize the transfer of the heat to the heat transfer medium. An example of such an arrangement is illustrated in FIG. 9.

It will be understood that the foregoing also applies where (as illustrated in FIGS. 4C and 4D) the loop circuit 34 directly engages the photovoltaic panel 27. Preferably, parts of the loop circuit are positioned relative to the photovoltaic panel for optimum heat transfer to the heat transfer medium in the loop circuit.

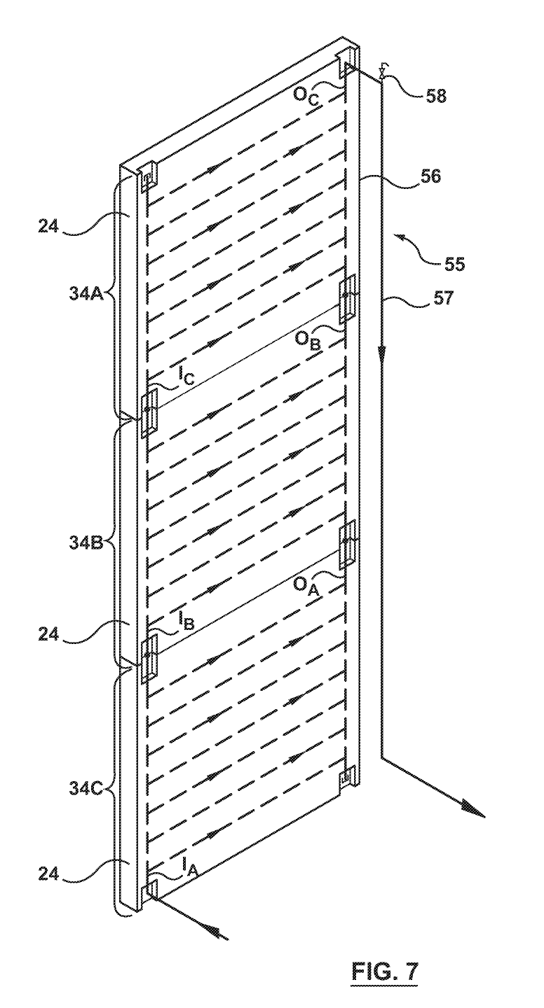

It will be appreciated by those skilled in the art that many arrangements of the wall assemblies are possible. For instance, in FIG. 7, an arrangement in which three wall assemblies are vertically stacked is shown. In this arrangement, the loop circuits (designated 34A, 34B, 34C in FIG. 7 for convenience) are interconnected. Inlets (identified as I_{A}, I_{B}, and I_{c}) are connected together in series, as are outlets (O_{A}, O_{B}, O_{C}). Many different arrangements will occur to those skilled in the art.

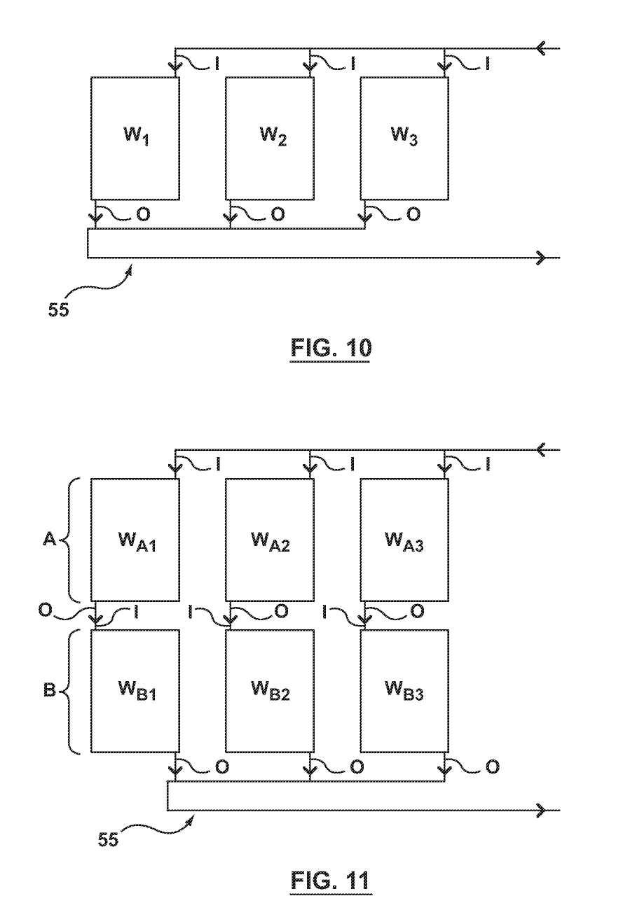

In one embodiment, and as illustrated (for example) in FIG. 10, each loop circuit 34 is connected in series to at least one other of said loop circuits located adjacent thereto. For clarity of illustration, the wall assemblies in FIG. 10 are identified as W₁, W₂, and W₃. (It will be understood that the wall assemblies in FIG. 10 may be any of the embodiments thereof described above.) In each wall assembly illustrated in FIG. 10, the inlet of the loop circuit therein is identified as “I”, and the outlet therefrom is identified as “O”.

In FIG. 11, two rows of wall assemblies are shown connected in series. For clarity of illustration, one row is identified as “row A”, and the other row is identified as “row B”. The wall assemblies in the respective rows are identified as “W_{A1}” to “W_{A3}” and “W_{B1}” to “W_{B3}” and inlets and outlets are identified in FIG. 11 as “I” and “O”.

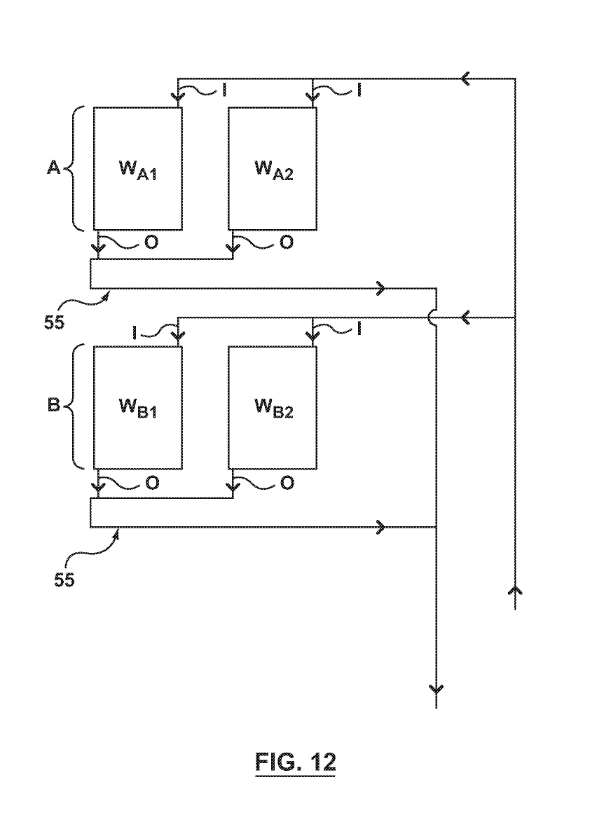

In one embodiment, the invention provides a structure 38 in which each loop circuit 34 is connected in parallel relative to at least one other of the loop circuits located adjacent thereto. In FIG. 12, two sets (set “A” and set “B”) of wall assemblies identified as “W_{A1}”, “W_{A2}”, “W_{B1}”, and “W_{B2}” are connected in parallel. The inlets and outlets of the loop circuits in the wall assemblies are identified in FIG. 12 as “I” and “O”.

It is preferred that each loop circuit 34 additionally includes one or more pressure equalizing means 55. For instance, in one embodiment, the pressure equalizing means 55 is a manifold for receiving the heat exchange medium from the loop circuit respectively at substantially the same pressure, to permit the heat exchange medium to flow into and out of the manifold at substantially equal rates of flow.

An example of the manifold 55 can be seen in FIG. 8, in which a first part 56 of the manifold 55 directs heat transfer medium exiting the loop circuit 34 in a first direction (indicated by arrow “M” in FIG. 8), and a second part 57 in fluid communication therewith directs the exiting heat transfer medium in a second reverse flow direction (i.e., as indicated by arrow “N” in FIG. 8). (As can be seen in FIG. 8, in one embodiment, the outlet tube 80 of the loop circuit 34 preferably is the first part 56 of the manifold 55.) The second direction is substantially opposite to the first direction. This arrangement has been found to be effective to substantially equalize pressure throughout the loop circuit, or (as shown, for example, in FIGS. 7 and 10-12) throughout a number of connected loop circuits.

In addition, it is advantageous to include a release valve 58 (FIG. 7) for automatic release of air trapped in the loop circuit(s). As those skilled in the art would be aware of automotive air release valves, no further explanation of the operation thereof is necessary.

It will be understood that the photovoltaic panel and the other elements of the wall assembly are exemplary. The wall assembly and the elements thereof may be provided in various forms. Those skilled in the art will appreciate that many different varieties of photovoltaic panels, including different varieties of photovoltaic cells, are available. The photovoltaic panel(s) in the wall assembly, and in the wall system, may have any suitable shape, and may be positioned in any suitable configuration. The wall assemblies may be positioned in the structure to suit architectural requirements, whether such requirements are aesthetic and/or practical.

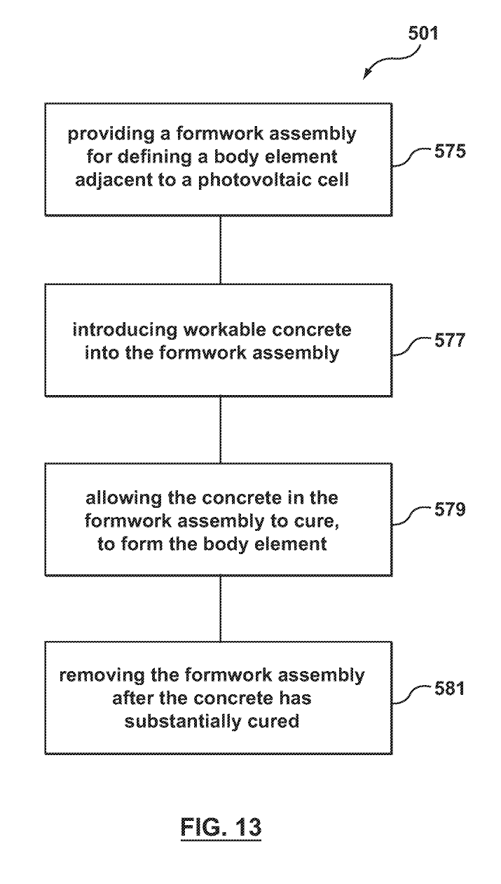

An embodiment of a method 501 of the invention of forming the wall assembly is schematically illustrated in FIG. 13. The method 501 includes, first, providing a formwork assembly 84 (FIGS. 1-3) for defining the body element 24 adjacent to the photovoltaic panel 27 (step 575, FIG. 13). Next, workable concrete 86 is introduced into the formwork assembly (step 577). The concrete in the formwork assembly 84 is then allowed to cure, to form the body element 24 (step 579). Finally, the formwork assembly 84 is removed after the concrete is substantially cured (step 581).

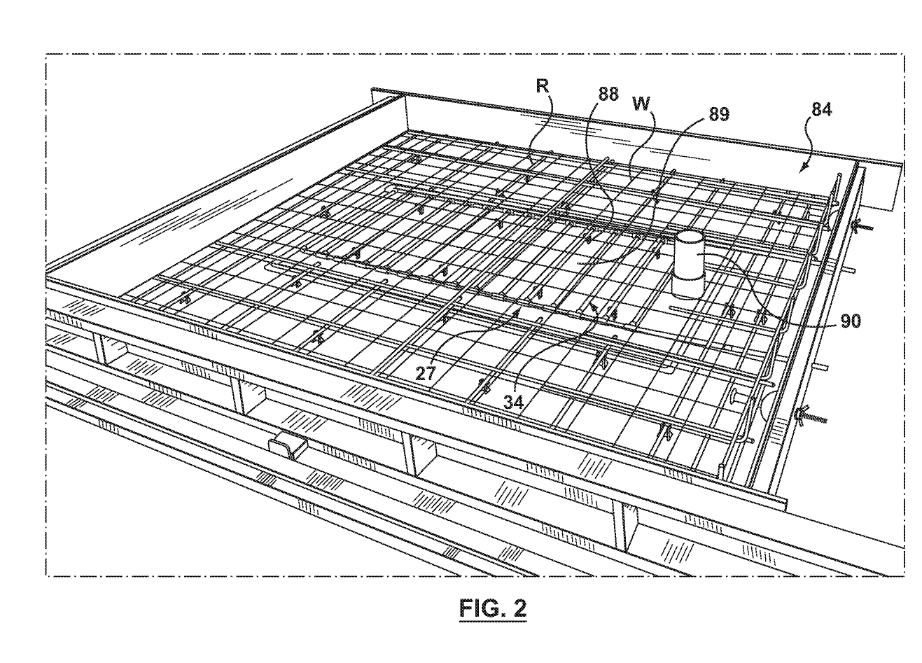

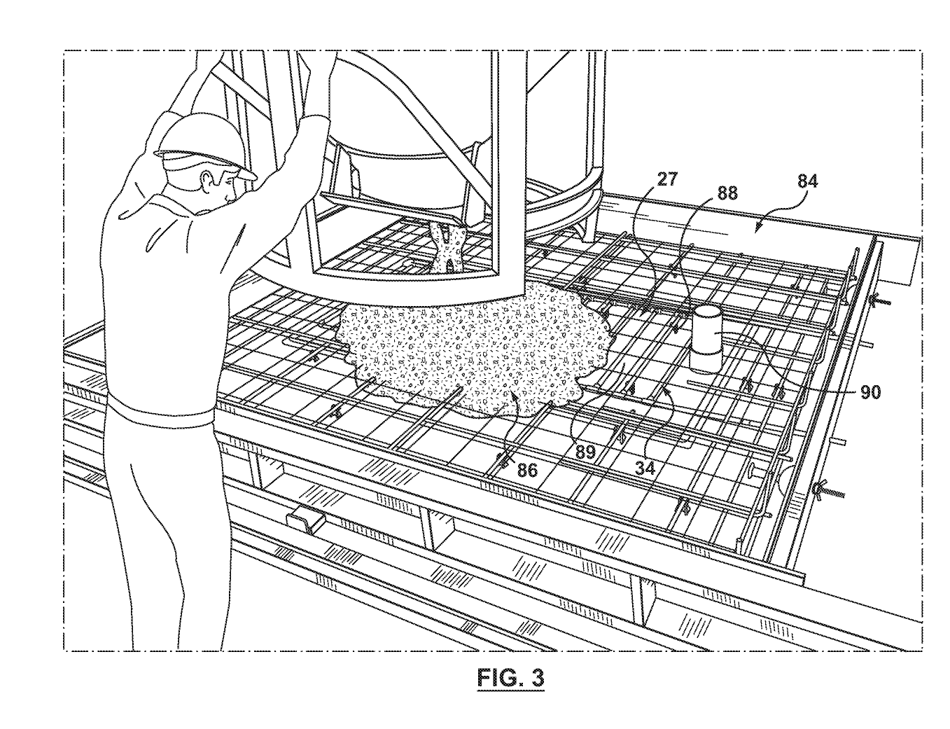

The body element 24 preferably is reinforced concrete. Accordingly, and as can be seen in FIGS. 2 and 3, rebar (“R”) and wire (“W”) preferably are positioned inside the formwork assembly 84, so that they may become embedded in the concrete. Preferably, supports 88 are positioned between the loop circuit 34 and the rear side 89 of the photovoltaic panel 27, to result in the engagement portion 36 of the body element 34.

Preferably, the wall assembly 20 includes wires (schematically illustrated in FIG. 6, and designated therein by reference numeral 30) which lead out of the rear side 89 of the photovoltaic panel 27. Those skilled in the art will appreciate that there are many different ways to position or arrange the wires, which are for distributing electricity generated by the photovoltaic cells 28. For example, a tube 90 is illustrated in FIGS. 2 and 3, for protecting the wires.

It will also be appreciated by those skilled in the art that the electrical energy generated by the photovoltaic cells may be utilized in many different ways. For example, the electrical energy which is generated may be distributed to the electrical distribution network in the building in which the wall assembly is installed. Because DC electrical current is produced by the photovoltaic cells, if the electricity generated by the photovoltaic panel 27 is to be distributed in the building, then the regulator 30 preferably includes an inverter to convert DC power to AC power. In addition, and as shown in FIG. 6, circuit breakers (designated 91A and 91B in FIG. 6 for clarity) preferably are also included in a power generation module, for safety, and a meter may be included. As is well known, the photovoltaic cells may be connected in parallel or in series, depending on system requirements.

As can be seen, for instance, in FIG. 4A, the photovoltaic panel 27 preferably is secured to the body element 24 by the means 32, which preferably include a frame 92, fasteners 94, and plugs 96. The fasteners 94 preferably are screws which are receivable in the plugs 96 (FIG. 4A), to secure the frame 92 to the body element 24. For clarity of illustration, only one plug 96 is illustrated in FIG. 4A. It will be understood that all the screws 94 shown in FIGS. 4A-4C are positioned in plugs 96, which are generally omitted, for clarity of illustration. In addition, it will also be understood that the frame 92 in FIG. 4D is held on the body element 24 by fasteners 94 which are received in plugs 96. The fasteners and plugs are omitted from FIG. 4D for clarity of illustration.

The means 32 for attaching the photovoltaic panel 27 to the body element 24 described above is preferred because it allows the photovoltaic panel 27 to be removed while the wall assembly 20 remains mounted in the structure 38. The removability of the photovoltaic panel 27 from the body element 24 may be important in practice, because photovoltaic panels may malfunction or deteriorate. As is known, the plugs 96 (not shown in FIGS. 2 and 3) are positioned in the formwork assembly 84 before the concrete 86 is positioned therein, so that the plugs 96 are held in the body element 24.

As can be seen, for instance, in FIG. 4A, in one embodiment, the frame 92 is mounted so that its exposed surfaces 97 are substantially flush, or even, with the exterior surface 40 of the body element 24. However, as can also be seen in FIG. 4A, the front surface 42 of the photovoltaic panel 27 preferably is set back from the exposed surfaces 97 of the frame 92, by a distance “X”. The photovoltaic panel 27 is set back in this way because the frame 92 simply engages the photovoltaic panel 27 around its periphery, i.e., without covering photovoltaic cells 28. Preferably, the setback distance X is minimized. That is, the position of the front surface 42 relative to the exterior surface 40 of the body element 24, i.e., almost flush with the exterior surface 40, is intended be a close as possible to alignment with the exterior surface 40, to minimize the possibility of shadows (i.e., “shading”) created by the body element affecting the performance of the photovoltaic cells 28, while utilizing a simple frame design. Those skilled in the art will appreciate that various alternative means may be used for securing the photovoltaic panel 27 to the body element 24. For example, a frame and a photovoltaic panel could be devised which would cooperate with a body element formed to position the front surface substantially flush (or even) with the exterior surface of the body element.

### INDUSTRIAL APPLICABILITY

In use, once the wall assembly 20 is installed, the heat transfer medium is pumped through the loop circuit 34. As described above, heat is transferred from the body element 24 to the heat transfer medium. In addition, and also as described above, heat generated by operation of the photovoltaic cells 28 is transferred to the heat transfer medium. The heat energy which is transferred to the heat transfer medium is ultimately transferred elsewhere, as described above, e.g., via a heat pump. Once much of the heat energy has been transferred from the heat transfer medium, the heat transfer medium is recirculated to the loop circuit 34, for transfer of further heat energy to the heat transfer medium. Electrical energy generated by the photovoltaic cells is also utilized as desired.

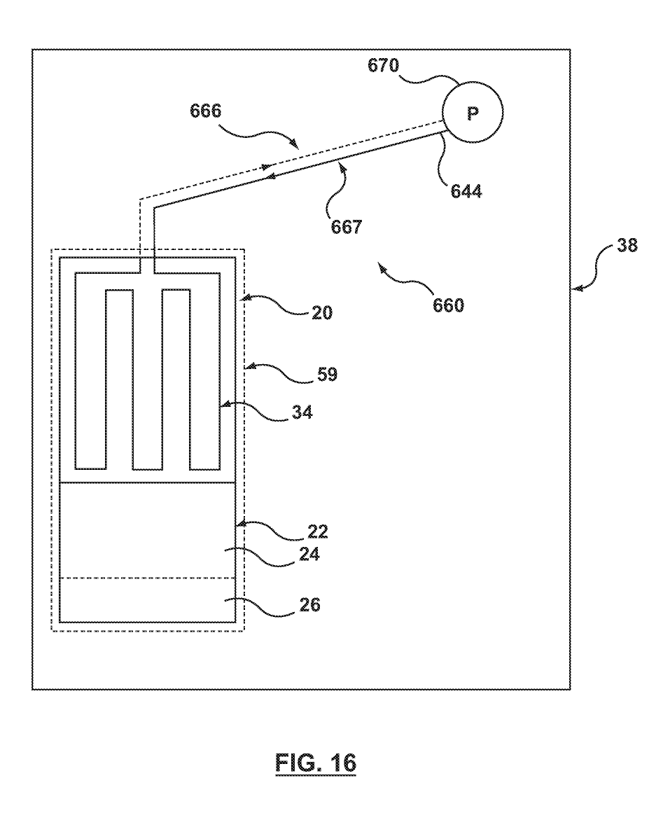

In another alternative embodiment, as illustrated in FIG. 16, the wall system 660 preferably includes the power generation subassembly 22 and a heat exchange subassembly 666 including one or more pumps 670 and one or more circuits 667 in fluid communication with the pump(s) 670. The pump(s) 670 is adapted for circulating the heat transfer medium therethrough. The circuit 667 preferably includes one or more end portions 644 positioned proximal to the pump(s), and one or more loop portions 34 in fluid communication with the end portion(s) 644. Each loop circuit 34 preferably is at least partially engaged with the power generation subassembly 22 for transfer of heat energy therebetween for moderating a temperature of the body element 34, for controlling heat transfer through the body element 24. Preferably, and as described above, the heat transfer is effected via conduction.

It will be understood that the wall assembly 20 (or a number thereof) is included in a wall unit 59, e.g., in an exterior wall or a roof of the structure 38, as indicated in FIG. 16. As described above, and as shown in FIGS. 5A and 5B, the increased temperature of the body element (i.e., increased as compared to a building wall not including the loop circuit) moderates heat loss through the wall of the structure in which the wall system is installed.

It will be appreciated by those skilled in the art that the invention can take many forms, and that such forms are within the scope of the invention as described above. The foregoing descriptions are exemplary, and their scope should not be limited to the preferred versions provided therein.

We claim:

1. A method of moderating an operating temperature of at least one photovoltaic panel, the method comprising:
forming at least one power generation subassembly comprising:
at least one body element comprising concrete;
at least one photovoltaic power generation module, comprising:
said at least one photovoltaic panel operable at the operating temperature within a predetermined range of operating temperatures;
means for attaching said at least one photovoltaic panel to said at least one body element;
providing at least one circuit with a heat transfer medium therein in fluid communication with at least one pump, for circulating the heat transfer medium through said at least one circuit, said at least one circuit comprising at least one loop circuit and an end portion;
providing at least one engagement portion in said at least one body element, said at least one engagement portion being positioned between and engaged with said at least one photovoltaic panel and said at least one loop circuit;
incorporating said at least one power generation subassembly into a structure; and
permitting heat energy to be transferred between said at least one photovoltaic panel and the heat transfer medium via said at least one engagement portion to maintain the operating temperature of said at least one photovoltaic panel within the predetermined range of operating temperatures.

2. A method according to claim 1 in which said at least one body element is a load-bearing element of the structure.

3. A method according to claim 1 in which said at least one body element is a non-load-bearing element of the structure.

4. A method according to claim 1 additionally comprising:
providing a heat exchanger with a heat exchange medium therein that flows therethrough;
positioning the end portion proximal to the heat exchanger for heat transfer between the heat transfer medium and the heat exchange medium; and
permitting heat transfer between the heat transfer medium and the heat exchange medium.

5. A method according to claim 1 additionally comprising:
providing a heat exchanger with a heat exchange medium therein that flows therethrough;
positioning the end portion proximal to the heat exchanger for heat transfer between the heat transfer medium and the heat exchange medium;
positioning the heat exchanger for heat exchange between the heat exchange medium and an indoor fluid in the structure; and
permitting heat exchange between the heat transfer medium and the indoor fluid via the heat exchange medium.

6. A method according to claim 1 in which said at least one circuit comprises a plurality of transverse tubes and at least one manifold formed for receiving the heat transfer medium from the transverse tubes respectively at substantially the same pressure, to permit the heat transfer medium to flow into said at least one manifold from each said transverse tube connected therewith at substantially equal rates of flow respectively.

7. A method according to claim 1 additionally comprising:
providing a closed loop ground heat exchanger comprising a supplemental loop circuit in which a supplemental heat exchange medium is circulatable, the supplemental loop circuit comprising a portion thereof located proximal to the end portion, for exchange between the supplemental heat exchange medium and the heat transfer medium flowing through the end portion; and
permitting heat exchange between the heat transfer medium flowing through the end portion and the supplemental heat exchange medium.

8. A method of moderating an operating temperature of at least one photovoltaic panel, the method comprising:
forming at least one power generation subassembly comprising:
at least one body element comprising concrete;
at least one photovoltaic power generation module, comprising:
at least one photovoltaic panel comprising at least one photovoltaic cell for converting solar energy into electricity, said at least one photovoltaic panel being operable at the operating temperature within a predetermined range of operating temperatures;
means for attaching said at least one photovoltaic panel to said at least one body element;
providing at least one circuit in fluid communication with at least one pump, for circulating a heat transfer medium through said at least one circuit, said at least one circuit comprising at least one loop circuit and an end portion;
providing at least one engagement portion in said at least one body element, said at least one engagement portion being positioned between and engaged with said at least one photovoltaic panel and said at least one loop circuit;
incorporating said at least one power generation subassembly into a structure;
permitting heat energy generated upon said at least one photovoltaic panel being exposed to the solar energy to be transferred therefrom to the heat transfer medium via said at least one engagement portion, to maintain the operating temperature of said at least one photovoltaic panel within the predetermined range of operating temperatures.

9. A method according to claim 8 additionally comprising:
providing a heat exchanger with a heat exchange medium therein that flows therethrough;
positioning the end portion proximal to the heat exchanger for heat transfer from the heat transfer medium in the end portion to the heat exchange medium in the heat exchanger; and
permitting heat transfer from the heat transfer medium to the heat exchange medium.

10. A method according to claim 8 additionally comprising:
providing a heat exchanger with a heat exchange medium therein that flows therethrough;
positioning the end portion proximal to the heat exchanger for heat transfer between the heat transfer medium and the heat exchange medium;
positioning the heat exchanger for heat exchange between the heat exchange medium and an indoor fluid in the structure; and
permitting heat exchange from the heat transfer medium to the indoor fluid via the heat exchange medium.

11. A method according to claim 8 in which said at least one circuit comprises a plurality of transverse tubes and at least one manifold formed for receiving the heat transfer medium from the transverse tubes respectively at substantially the same pressure, to permit the heat transfer medium to flow into said at least one manifold from each said transverse tube connected therewith at substantially equal rates of flow respectively.

12. A method of moderating an operating temperature of at least one photovoltaic panel, the method comprising:
forming at least one power generation subassembly comprising:
at least one body element comprising concrete;
at least one photovoltaic power generation module, comprising:
at least one photovoltaic panel comprising at least one photovoltaic cell for converting solar energy into electricity, said at least one photovoltaic panel being operable at the operating temperature within a predetermined range of operating temperatures;
means for attaching said at least one photovoltaic panel to said at least one body element;
providing at least one circuit in fluid communication with at least one pump, for circulating a heat transfer medium through said at least one circuit, said at least one circuit comprising at least one loop circuit and an end portion;
providing at least one engagement portion in said at least one body element, said at least one engagement portion being positioned between and engaged with said at least one photovoltaic panel and said at least one loop circuit;
incorporating said at least one power generation subassembly into a structure;
permitting heat energy to be transferred from the heat transfer medium to said at least one photovoltaic panel via said at least one engagement portion, to maintain the operating temperature of said at least one photovoltaic panel within the predetermined range of operating temperatures.

13. A method according to claim 12 additionally comprising:
providing a heat exchanger with a heat exchange medium therein that flows therethrough;
positioning the end portion proximal to the heat exchanger for heat transfer between the heat transfer medium and the heat exchange medium; and
permitting heat exchange from the heat exchange medium to the heat transfer medium.

14. A method according to claim 12 additionally comprising:
providing a heat exchanger with a heat exchange medium therein that flows therethrough;
positioning the end portion proximal to the heat exchanger for heat exchange between the heat transfer medium and the heat exchange medium;
positioning the heat exchange medium for heat exchange between the heat exchange medium and an indoor fluid in the structure; and
permitting heat exchange from the indoor fluid to the heat transfer fluid via the heat exchange medium.

15. A method according to claim 12 in which said at least one circuit comprises a plurality of transverse tubes and at least one manifold formed for receiving the heat transfer medium from the transverse tubes respectively at substantially the same pressure, to permit the heat transfer medium to flow into said at least one manifold from each said transverse tube connected therewith at substantially equal rates of flow respectively.

16. A method of moderating an operating temperature of at least one photovoltaic panel, the method comprising:
forming at least one power generation subassembly comprising:
at least one body element comprising concrete;
at least one photovoltaic power generation module, comprising:
said at least one photovoltaic panel operable at the operating temperature within a predetermined range of operating temperatures;
means for attaching said at least one photovoltaic panel to said at least one body element;
providing at least one circuit with a heat transfer medium therein in fluid communication with at least one pump, for circulating the heat transfer medium through said at least one circuit, said at least one circuit comprising at least one loop circuit and an end portion;
incorporating said at least one power generation subassembly into a structure; and
permitting heat energy to be transferred between said at least one photovoltaic panel and the heat transfer medium to maintain the operating temperature of said at least one photovoltaic panel within the predetermined range of operating temperatures.
